(19) United States
(12) Patent Application Publication
(10) Pub. No.: US 2024/0286179 A1
(43) Pub. Date: Aug. 29, 2024

(54) METHODS AND COMPOSITIONS FOR WASTE MANAGEMENT SYSTEMS

(71) Applicants: Anika Lakshmi MOOTHA, Coppell, TX (US); Venkateswara Vinod Mootha, Coppell, TX (US); Aneesh Vankateswara Mootha, Coppell, TX (US)

(72) Inventors: Anika Lakshmi MOOTHA, Coppell, TX (US); Venkateswara Vinod Mootha, Coppell, TX (US); Aneesh Vankateswara Mootha, Coppell, TX (US)

(21) Appl. No.: 18/444,159

(22) Filed: Feb. 16, 2024

Related U.S. Application Data
(60) Provisional application No. 63/485,574, filed on Feb. 17, 2023.

(51) Int. Cl. B09B 3/60; B09B 3/70

(52) U.S. Cl. CPC B09B 3/60; B09B 3/70

(57) ABSTRACT

Methane is a potent greenhouse gas contributing to the acceleration of climate change due to its heat trapping affinity. Described herein are methods for the reduction of methane production in waste management systems by utilizing microbial populations that produce Cld enzymes and addition of a source of NaClO₂. The compositions as described herein may be used to reduce methanogenesis in a landfill or other waste management system.

### CROSS-REFERENCE

The present application claims the benefit of U.S. Provisional Application No. 63/485,574, entitled “Methods and Compositions for Waste Management Systems,” filed on Feb. 17, 2023, which application is herein incorporated by reference in its entirety for all purposes.

### BACKGROUND

Climate change is arguably the most salient issue facing current generations and its cataclysmic impacts around the world have already begun to be observed. Moreover, methane, due to its heat trapping affinity (at least 28 times that of CO₂), is one of the most potent greenhouse gases and has accelerated climate change. Methane is emitted from a variety of anthropogenic and natural sources. Waste management systems such as landfills are the 4th leading source of man-made methane emissions in the United States. Landfills produced 60 to 69 teragrams (10¹² grams) of methane annually between 2000 and 2017. In the United States and other high GDP per capita countries, landfills can account for up to 20% of net methane emissions. Methods to reduce methane production from waste management systems (e.g., landfills) are needed to decelerate climate change.

Organic material such as food waste in landfills is decomposed in four phases by bacteria, as shown in FIG. 1. In the first phase, bacteria utilize aerobic respiration using oxygen to decompose organic material into carbon dioxide and water. In the last 3 phases, bacteria utilize anaerobic respiration to decompose organic material. In phase 2, fermentative microbes hydrolyze cellulose-laden waste to generate labile organic substrates to facilitate fermentation and production of organic acids which reduce the pH in landfill with phase 3 characterized by rapid methanogenesis by anaerobic microbes which slows in phase 4. Biogas in landfills can include methane and/or carbon dioxide. For example, landfill biogas can include of about 45-60% methane and about 45-60% carbon dioxide. The anaerobic waste decomposition relies on a symbiotic relationship between fermentative/hydrolytic bacteria, acetogens and methanogens.

One potential solution to mitigate landfill methane gas emission is to introduce chlorite, chlorate, or perchlorate into landfills as a source of oxygen. The reduction of these oxidized chlorine species can result in the generation of significant amounts of molecular oxygen. Soil concentrations of chlorite, chlorate, or perchlorate can be in the range of about 0.01, 0.1, 1.0, 2.0, 5.0, 10.0, 20.0, 30.0, 40.0, 50.0, 60.0, 70.0, 80.0, 90.0, 100, 150, 200 gm/kg or more can be used based on the waste composition and needs of the waste management system.

For example, sodium chlorite can be introduced into landfills as a source of oxygen to facilitate aerobic respiration. The chemical reaction below is the reduction of chlorite resulting in the loss of oxygen molecule and gain of electron. Prokaryotic chlorite O₂-lyase or chlorite dismutase (Cld) enzymes uses sodium chlorite (NaClO₂) as a substrate to produce oxygen and chloride, per the below reaction. About 5% of bacteria and archaea genera have at least one microorganism with a Cld enzyme.

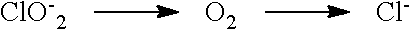

The chemical reaction of the reduction of chlorite (ClO₂⁻) to generate molecular oxygen (O₂) and chloride ion (Cl⁻), as shown above, can be catalyzed by the chlorite dismutase (Cld) enzyme. The reduction of perchlorate (ClO₄⁻) to chlorate (ClO₃⁻) can be catalyzed by the perchlorate reductase (Pcr) enzyme and the reduction of chlorate (ClO₃⁻) to chlorite (ClO₂⁻) can be catalyzed by the chlorate reductase (Clr) enzyme. The reduction of perchlorate (ClO₄⁻), chlorate (ClO₃⁻), and chlorite (ClO₂⁻) can be catalyzed by perchlorate reductase (Pcr), chlorate reductase (Clr), and chlorite dismutase (Cld) enzymes, respectively, to generate molecular oxygen (O₂) and chloride ion (Cl⁻) and may be a useful strategy to reduce methane production and emission from waste management systems including municipal solid waste (MSW) landfills, vegetation waste disposal areas, and animal waste landfills.

### SUMMARY

The invention relates to a method of reducing of reducing biogas levels in a waste management system including contacting the waste management system with oxidized chlorine species including a chlorite (ClO₂⁻) containing compound, a chlorate (ClO₃⁻) containing compound, a perchlorate (ClO₄⁻) containing compound, or a combination thereof.

The invention also relates to a waste management system comprising contacting the waste management system with a chlorite (ClO₂⁻) containing compound, a chlorate (ClO₃⁻) containing compound, a perchlorate (ClO₄⁻) containing compound, or a combination thereof.

The invention further relates to a method of promoting aerobic respiration of a microorganism in a waste management system comprising contacting the waste management system with a chlorite (ClO₂⁻) containing compound, a chlorate (ClO₃⁻) containing compound, a perchlorate (ClO₄⁻) containing compound, or a combination thereof.

The invention additionally relates to a method of reducing anerobic activity of a microorganism in a waste management system comprising contacting the waste management system with a chlorite (ClO₂⁻) containing compound, a chlorate (ClO₃⁻) containing compound, a perchlorate (ClO₄⁻) containing compound, or a combination thereof.

The invention additionally relates to a method to catalyze the chemical reduction of oxidized chlorine species using a chlorite dismutase (Cld) enzyme, a chlorate reductase (Clr) enzyme, a perchlorate reductase (Pcr) enzyme, or a combination thereof to generate molecular oxygen.

### BRIEF DESCRIPTION OF THE DRAWINGS

FIG. 1 shows landfill gas emission phases.

FIG. 2 shows creek water samples. 1A is 16 g (0.053 g/ml), 1B is 32 g (0.11 g/ml), and 1C is 0 g of NaClO₂. No balloon inflation two days after experiment set-up.

FIG. 3 shows alluvial creek bed Soil samples. 0 g and 16 g (30 g/kg soil concentration) of NaClO₂. Rapid balloon inflation within 6 hours providing evidence of the presence of Cld enzymes.

FIG. 4 shows 4 g NaClO₂ in 526 g creek bed soil (7.6 g/kg soil concentration) for experiment to quantify oxygen production in soil samples.

FIG. 5 shows 145 mL of measurable gas production was noted over a 65-hour period before plateauing. This measurable volume is ˜14% of the theoretical oxygen yield from the reduction of 4 grams NaClO₂, using the Ideal Gas Law.

FIG. 6 shows anoxic composting model system in 2 liter plastic soda bottle with 1 cup of organic food waste from kitchen waste with coffee grounds, 1 cup of leaves or grass clippings, 1 cup of shredded paper, and 4 cups of wet creek bed soil with 16 g of NaClO₂ (9.6 g/kg soil concentration) or 4 cups of wet creek bed soil without NaClO₂. Gas produced in this experiment was collected using the water displacement method.

FIG. 7 shows that using sodium chlorite, gas production was noted at one hour after experiment set-up; most of the measurable gas production occurred within the first 46 hours which plateaued at ˜134 hours. Without sodium chlorite, no gas production was noted in the first 200 hours after experiment set-up; after which, gas was produced continuously at a rate of ˜2 mL per hour until termination of experiment.

FIG. 8 shows gas composition in anoxic composting model system using Basic Multi-gas Detector Model: FD4A Forensics Detectors. Detection range of methane (CH₄): 0-100% Lower Explosive Limit (LEL). LEL of CH₄ is 5% of gas volume. Reading of HHH indicates that CH₄ has exceeded 100% LEL and is >5% of gas volume (>50,000 ppm).

FIG. 9 shows Gas composition in an anoxic composting model system at 12, 23, and 34 days after experiment set-up. High levels of methane were noted in the composting model without NaClO₂ at days 12, 23, and 34. In the composting model with NaClO₂, low levels of methane were noted at day 12 and no methane was detected at days 23 and 34.

FIG. 10 shows anoxic composting system mimics the phases of bacterial decomposition in landfills. In anoxic composting model without NaClO₂ anaerobic bacteria produce a steady rate of methane as seen in Phase III and Phase IV in landfills. With the use of sodium chlorite in landfills, it has been proposed to prolong Phase I (aerobic decomposition) by the generation of oxygen and reduce methanogenesis.

FIG. 11 shows photographs and characteristics of surface creek soil, deep creek soil, and landfill cover soil samples.

FIG. 12 shows landfill cover soil, surface creek soil, and deep creek soil samples with 16 g (30 g/kg soil concentration) of NaClO₂. Rapid balloon inflation within 6 hours provides evidence of Cld enzymatic activity in both the surface and deep creek bed soil samples but not in the landfill soil cover sample.

FIG. 13 shows relative proportions of top phyla are comparable in deep and surface soil samples. Of these 10 phyla, four are known to contain the Cld enzymes based on published genome sequencing studies: Proteobacteria (2%), Chloroflexi (1%), Actinobacteriota (<1%), and Firmicutes (<1%).

FIG. 14 shows amongst the top 30 genera in surface and deep soil, the following genera known to harbor Cld: Bradyrhizobium (75%), Nitrospira (40%), Sphingomonas (5%), and Pseudomonas (1%) were detected.

FIG. 15 shows that to study the phylogenic relationship of the microbial community, the top 100 genera were selected to draw an evolutionary tree. Of the top 100 genera, 9 are known to harbor Cld. Of note, Nitrospira (40% with Cld) and Sphingomonas (5% with Cld) were relatively abundant in both surface and deep soil. Additionally, at least two genera that are well characterized to produce methane were detected: Methanosaeta and Candidatus Methanoperedens.

FIG. 16 shows the design of anoxic composting reactor to model landfill biogas emissions and a cartoon of anoxic composting reactor with soil samples layered with food waste and other organic materials found in landfills.

FIG. 17 shows set-up of anoxic composting reactors for each of the following four experimental conditions including a technical replicate for each: 4 cups of surface creek soil with 16 g of NaClO₂ (9.6 g/kg soil concentration), or 4 cups of surface creek soil without NaClO₂, or 4 cups of landfill cover soil with 16 g of NaClO₂, or 4 cups or landfill cover soil without NaClO₂.

FIG. 18 shows the anoxic composting reactors with surface creek soil samples mimic the 4 phases of bacterial decomposition in landfills. Surface creek soil with NaClO₂ results in immediate gas production over a 60 hour period with increasing levels of CO₂ consistent with aerobic respiration. In an anoxic composting model without NaClO₂, we detect a delayed onset of gas production at ˜day 10 when methane is detected and its levels rise to ˜32% at day 21 consistent with anaerobic respiration and high levels of methanogenesis. A larger volume of biogas was produced in creek soil reactors with NaClO₂ (328 ml+/−81) compared to creek reactors without NaClO₂ (240 ml+/−85 ml) (P-value=0.009, one-tailed paired t test). The millimoles of methane generated in creek soil reactors without NaClO₂ (mean=1.6+/−0.3) was significantly higher than in creek reactors with NaClO₂ (P-value=0.037, one-tailed paired t test).

FIG. 19 shows the anoxic composting reactors with landfill soil cover samples with or without NaClO₂ generated gas with lower levels of CO₂ consistent with lower levels of aerobic respiration. Biogas volumes were lower in landfill reactors (mean=120 ml+/−139) compared to that observed in creek reactors (mean=284 ml+/−85) likely due to lower microbial content.

### DETAILED DESCRIPTION

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used herein, the singular forms “a,” “an” and “the” include plural referents unless the context clearly dictates otherwise.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

As used herein, the term “biogas” refers to a gaseous renewable energy source produced from raw materials such as agricultural waste, manure, municipal waste, plant material, sewage, green waste, wastewater, and food waste. Biogas is produced by anaerobic digestion with anaerobic organisms or methanogens inside an anaerobic digester, biodigester or a bioreactor. The gas composition is primarily methane (CH₄) and carbon dioxide (CO₂) and may have small amounts of hydrogen sulfide (H₂S), moisture, siloxanes and other gases.

As used herein, the term “waste management system” refers to a planned system aimed at effectively controlling the production, storage, collection, transportation, processing and disposal of waste.

All publications, patents, and patent applications mentioned in this specification are herein incorporated by reference to the same extent as if each individual publication, patent, or patent application was specifically and individually indicated to be incorporated by reference.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, it will be understood that modifications and variations are encompassed within the spirit and scope of the instant disclosure. The preferred methods and materials are now described.

Provided herein is a method of reducing methane production with use of chlorite (ClO₂⁻). The method provides for use of chlorite (ClO₂⁻) to reduce methane gas production and/or emission from landfills including but not limited to municipal solid waste (MSW) landfills, vegetation waste disposal areas, and animal waste landfills. In some embodiments, chlorite (ClO₂⁻) is in the form of sodium chlorite (NaClO₂) or other chlorite (ClO₂⁻) containing compound. In some embodiments, chlorite dismutase (Cld) enzymes are used to catalyze the reduction of chlorite (ClO₂⁻) into oxygen (O₂) and chloride ion (Cl⁻). In some embodiments, chlorite dismutase (Cld) enzymes are provided in the form of bacteria, archaea, or other micro-organisms with naturally occurring Cld enzymes, recombinant bacteria, achaea, or other micro-organisms genetically engineered to express Cld enzymes, or purified recombinant Cld enzymes. Provided herein, is a method of reducing methane production with use of chlorate (ClO₃⁻). In some embodiments, the methods include using chlorate (ClO₃⁻) to reduce methane gas production and/or emission from landfills including but not limited to municipal solid waste (MSW) landfills, vegetation waste disposal areas, and animal waste landfills. In some embodiments, chlorate (ClO₃⁻) is in the form of sodium chlorate (NaClO₃), potassium chlorate (KClO₃), magnesium chlorate Mg(ClO₃)₂ or other chlorate (ClO₃⁻) containing compound. In some embodiments, chlorate reductase enzymes are used to catalyze the reduction of chlorate (ClO₃⁻) into chlorite (ClO₂⁻). In some embodiments, chlorite dismutase (Cld) enzymes are used to catalyze the reduction of chlorite (ClO₂⁻) into oxygen (O₂) and chloride ion (Cl⁻). In some embodiments, chlorite dismutase (Cld) enzymes are provided in the form of bacteria, archaea, or other micro-organisms with naturally occurring Cld enzymes, recombinant bacteria, archaea, or other micro-organisms genetically engineered to express Cld enzymes, or purified recombinant Cld enzymes. Provided herein, is a method of reducing methane production with use of perchlorate (ClO₄⁻). In some embodiments, the method includes use of perchlorate (ClO₄⁻) to reduce methane gas production and/or emission from landfills including but not limited to municipal solid waste (MSW) landfills, vegetation waste disposal areas, and animal waste landfills. In some embodiments, the perchlorate (ClO₄⁻) is in the form of sodium perchlorate (NaClO₄), ammonium perchorate ([NH₄]ClO₄), perchloric acid (HClO₄), potassiuM perchlorate (KClO₄), or other perchlorate (ClO₄⁻) containing compound. In some embodiments, perchlorate reductase enzymes are used to catalyze the reduction of perchlorate (ClO₄⁻) into chlorate (ClO₃⁻). In some embodiments, perchlorate reductase enzymes are provided in the form of bacteria, archaea, or other micro-organisms with naturally occurring perchlorate reductase enzymes, recombinant bacteria, archaea, or other micro-organisms genetically engineered to express perchlorate reductase enzymes or purified recombinant perchlorate reductase enzymes. In some embodiments, chlorate reductase enzymes are used to catalyze the reduction of chlorate (ClO₃⁻) into chlorite (ClO₂⁻). In some embodiments, chlorate reductase enzymes are provided in the form of bacteria, archaea, or other micro-organisms with naturally occurring chlorate reductase enzymes, recombinant bacteria, archaea, or other micro-organisms genetically engineered to express chlorate reductase enzymes or purified recombinant chlorate reductase enzymes. In some embodiments, chlorite dismutase (Cld) enzymes are used to catalyze the reduction of chlorite (ClO₂⁻) into oxygen (O₂) and chloride ion (Cl⁻). In some embodiments, chlorite dismutase (Cld) enzymes are provided in the form of bacteria, archaea, or other micro-organisms with naturally occurring Cld enzymes, recombinant bacteria, archaea, or other micro-organisms genetically engineered to express Cld enzymes, or purified recombinant Cld enzymes.

In some embodiments, the techniques described herein relate to a method of reducing of reducing biogas levels in a waste management system including contacting the waste management system with a chlorite (ClO₂⁻) containing compound, a chlorate (ClO₃⁻) containing compound, a perchlorate (ClO₄⁻) containing compound, or a combination thereof.

In some embodiments, the techniques described herein relate to a method of reducing of reducing biogas levels in a waste management system including contacting the waste management system with oxidized chlorine species selected from a chlorite (ClO₂⁻) containing compound, a chlorate (ClO₃⁻) containing compound, a perchlorate (ClO₄⁻) containing compound, or a combination thereof.

In some embodiments, the techniques described herein relate to a method of increasing oxygen levels in a waste management system including contacting the waste management system with a chlorite (ClO₂⁻) containing compound, a chlorate (ClO₃⁻) containing compound, a perchlorate (ClO₄⁻) containing compound, or a combination thereof.

In some embodiments, the techniques described herein relate to a method of promoting aerobic respiration of a microorganism in a waste management system including contacting the waste management system with a chlorite (ClO₂⁻) containing compound, a chlorate (ClO₃⁻) containing compound, a perchlorate (ClO₄⁻) containing compound, or a combination thereof.

In some embodiments, the techniques described herein relate to a method of reducing anerobic activity of a microorganism in a waste management system including contacting the waste management system with a chlorite (ClO₂⁻) containing compound, a chlorate (ClO₃⁻) containing compound, a perchlorate (ClO₄⁻) containing compound, or a combination thereof.

In some embodiments, the techniques described herein relate to a method, further including contact the waste management system with a chlorite dismutase (Cld) enzyme, a chlorate reductase (Clr) enzyme, a perchlorate reductase (Pcr) enzyme, or a combination thereof.

In some embodiments, the techniques described herein relate to a method, further including contacting the waste management system with a population of microorganisms expressing one or more of a chlorite dismutase (Cld) enzyme, a chlorate reductase (Clr) enzyme, and a perchlorate reductase (Pcr) enzyme.

In some embodiments, the techniques described herein relate to a method, wherein the population of microorganisms are engineered to express one or more of the chlorite dismutase (Cld) enzyme, the chlorate reductase (Clr) enzyme, and the perchlorate reductase (Pcr) enzyme.

In some embodiments, the techniques described herein relate to a method, wherein the population of microorganisms includes bacteria, archaea, or a combination thereof.

In some embodiments, the techniques described herein relate to a method, wherein the chlorite (ClO₂⁻) containing compound is sodium chlorite (NaClO₂).

In some embodiments, the techniques described herein relate to a method, wherein chlorate (ClO₃⁻) containing compound is sodium chlorate (NaClO₃), potassium chlorate (KClO₃), or magnesium chlorate Mg(ClO₃⁻)₂.

In some embodiments, the techniques described herein relate to a method, wherein perchlorate (ClO₄⁻) containing compound is sodium perchlorate (NaClO₄), ammonium perchlorate ([NH₄]ClO₄), perchloric acid (HClO₄), or potassium perchlorate (KClO₄).

In some embodiments, the techniques described herein relate to a method, wherein the biogas is methane, carbon dioxide, or a combination thereof.

In some embodiments, the techniques described herein relate to a method or claim 4, wherein the microorganism is a bacteria or an archaea.

The following examples are provided to further illustrate the embodiments of the present invention but are not intended to limit the scope of the invention. While they are typical of those that might be used, other procedures, methodologies, or techniques known to those skilled in the art may alternatively be used.

### EXAMPLES

### Example 1

Testing Cld Enzyme Activity in Creek Bed Soil Samples and Ability to Reduce Methane Production in Anoxic Composting Systems with the Addition of Sodium Chlorite

Methane is a potent greenhouse gas contributing to the acceleration of climate change due to its heat trapping affinity. This study examined the hypothesis that the reduction of sodium chlorite (NaClO₂) with chlorite dismutase (Cld) enzymes can be utilized to reduce methanogenesis in an anoxic composting model system mimicking a landfill. Using a qualitative sampling device, creek freshwater and alluvial creek bed soil were examined for the presence of Cld enzymes. Cld enzymes were found to be abundant in creek bed soil. Next, the gas production from sodium chlorite placed in creek bed soil was quantified using the water displacement method. Using NaClO₂ and creek bed soil, ˜14% of the theoretical yield of oxygen was generated within ˜3 days. Finally, the utility of NaClO₂ to reduce methane production was tested in an anoxic composting model system. In the composting model with NaClO₂, gas production was noted within 1 hour of set-up with most of the measurable gas production occurring within ˜2 days, and there was no detection of methane using a 4-gas meter upon conclusion of the experiment at ˜34 days. In contrast, in the composting experiment without NaClO₂, no gas production was noted until ˜8 days when high levels of methane were detected; thereafter, continuous gas production at a rate of ˜2 mL/hr was observed until the termination of the experiment. Collectively, the results of this study indicate that the use of NaClO₂ and Cld enzymes may be a useful strategy to reduce the production and emission of methane from landfills.

### Methods

A qualitative sampling device was created using: 300 mL plastic water bottle, 7-inch balloon and 3×⅛ in rubber band. Freshwater, wet creek bed soil (alluvial soil), and dry creek bank soil samples were collected from a stream habitat (Denton Creek in Coppell, Texas). Samples were placed in a sampling device with or without sodium chlorite (0 g, 16 g, or 32 g) to screen for the presence of Cld enzymes by observing inflation of balloon.

Using water displacement method, the oxygen production and yield were calculated from 4 gm of sodium chlorite in a 300 mL wet creek bed soil sample (526 gm) placed in 500 mL Erlenmeyer flask with rubber stopper connected with rubber tubing to an inverted 1 L graduated beaker full of water and placed in a rectangular plastic tub with water.

A composting experiment was conducted in a 2-liter plastic soda bottle with 1 cup of organic food waste from kitchen waste with coffee grounds, 1 cup of leaves or grass clippings, 1 cup of shredded paper, and 4 cups of wet creek bed soil with 16 g of sodium chlorite (9.6 g/kg soil concentration) or 4 cups of wet creek bed soil without sodium chlorite. Gas produced in this experiment was collected using water displacement method. The %/Vol of methane was measured with a portable multi 4 gas detector with air gas sampling pump.

### Results

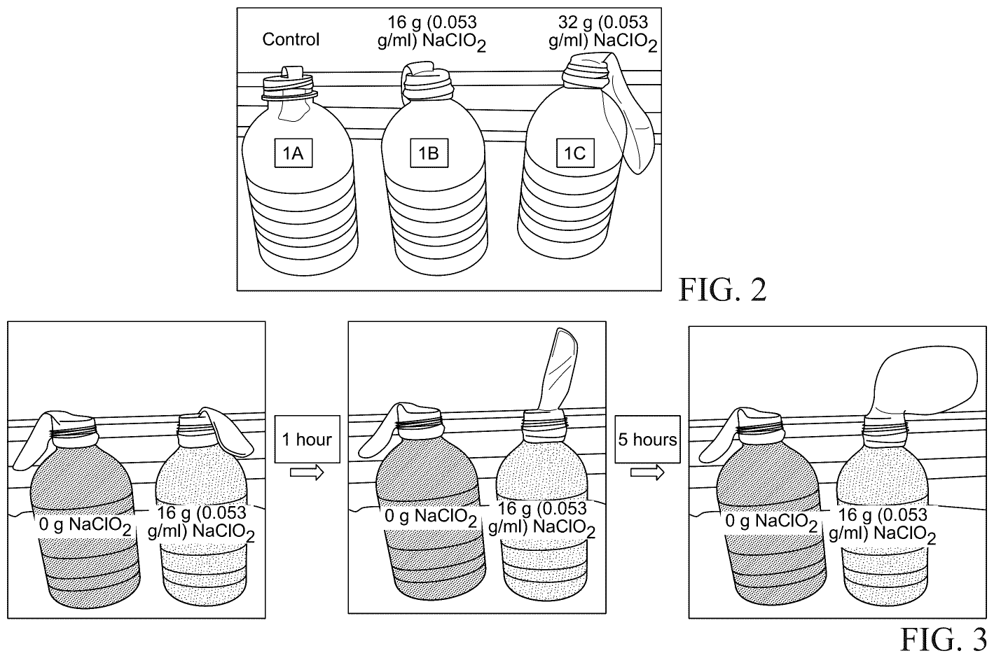

The creek water samples collected are shown in FIG. 2. Sample 1A was the control sample with 0 g of NaClO₂ added, Sample 1B has 16 g (0.053 g/ml) NaClO₂ added, and Sample 1C had 32 g (0.11 g/ml) NaClO₂ added. As seen in FIG. 2, there was no balloon inflation after 2 days.

The alluvial creek bed soil samples collected are shown in FIG. 3. The sample on the left side of each panel of FIG. 3 shows the creek bed soil sample with 0 g NaClO₂ added and the sample on the right side of each panel of FIG. 3 shows the creed bed soil sample with 16 g (0.053 g/ml) of NaClO₂ added. As shown in FIG. 3, there was rapid balloon inflation within 6 hours of the creek bed sample with 16 g (0.053 g/ml) of NaClO₂ added indicating the presence of Cld enzymes in the creek bed sample.

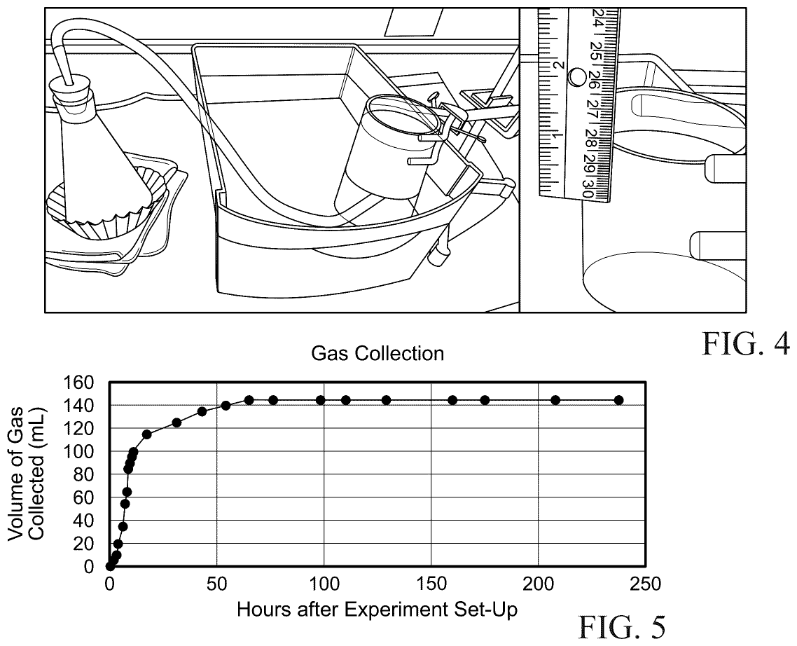

The gas production was then quantified from the reduction of sodium chlorite using the water displacement method, as shown in FIG. 4. As shown in FIG. 4, 4 g of NaClO₂ was added to 526 g of creek bed soil (7.6 g/kg soil concentration) and the oxygen production was quantified. FIG. 5 shows the oxygen production measured from the creek bed soil with NaClO₂ added over 240 hours. As seen in FIG. 5, 145 ml of measurable was production was observed over a 65-hour period before plateauing. This measurable volume was around 14% of the theoretical oxygen yield from the reduction of 4 grams NaClO₂ calculated using the Ideal Gas Law.

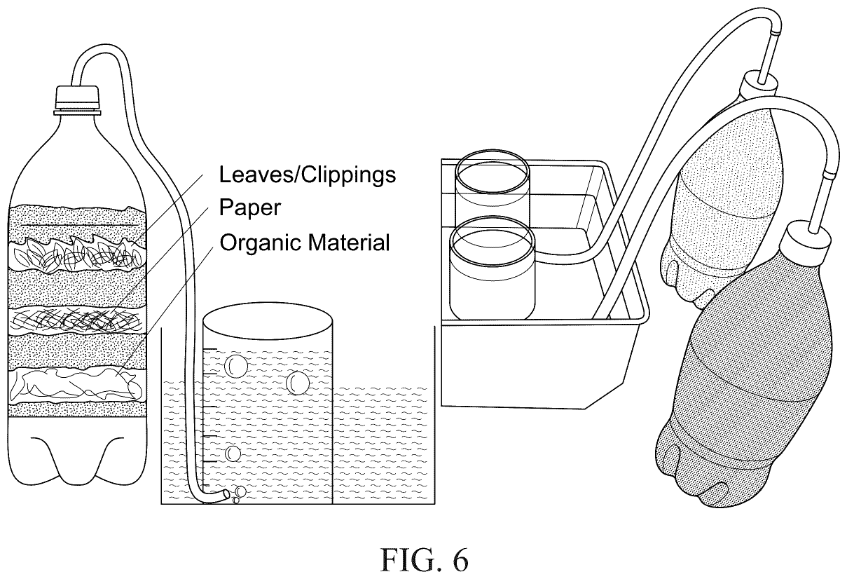

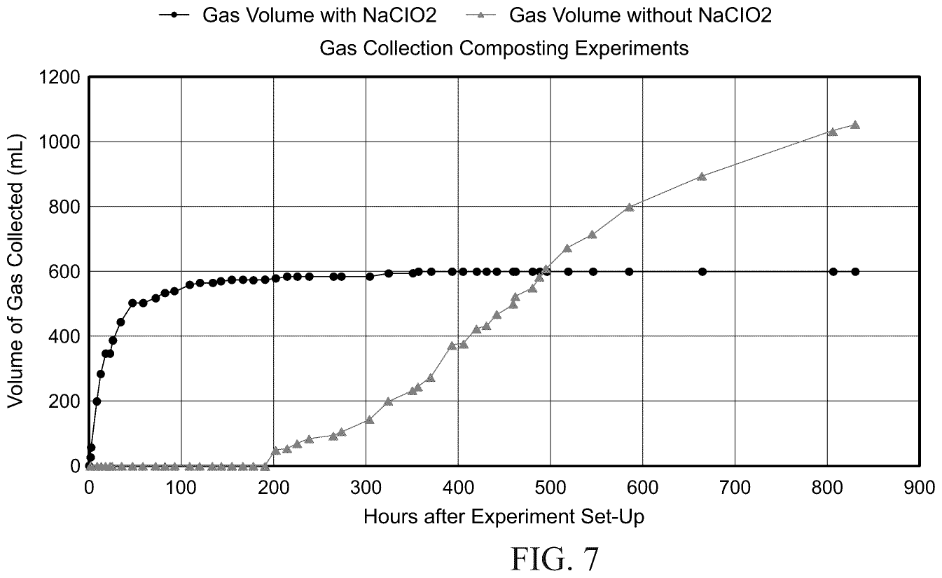

The utility of NaClO₂ and Cld enzymes in an anoxic composting model system was then tested. As shown in FIG. 6, the anoxic composting model system was made by using a 2-liter plastic soda bottle with 1 cup of organic food waste from kitchen waste with coffee grounds, 1 cup of leaves or grass clippings, 1 cup of shredded papers, and 4 cups of wet creek bed soil with 16 g of NaClO₂ (9.6 g/kg soil concentration) or 4 cups of wet creek bed soil without NaClO₂. The gas produced by the anoxic compound system shown in FIG. 6 was collected and measured by using the water displacement method. FIG. 7 shows the gas produced by the anoxic compound system shown in FIG. 6. As seen in FIG. 7, gas production from the anoxic composting model with wet creek bed soil with 16 g of NaClO₂ (9.6 g/kg soil concentration) was noted at one hour after the experiment set-up with most of the measurable gas production occurring within the first 46 hours which plateaued at about 134 hours. Also seen in FIG. 7, gas production from the anoxic composition model with wet creek bed soil with 0 g of NaClO₂ was not observed in the first 200 hours after the experiments set up after which gas production was observed continuously at a rate of about 2 ml per hour until the termination of the experiment.

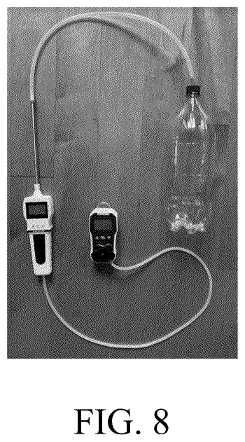

The gas composition of the gas produced in the anoxic composting systems shown in FIG. 6 was also measured, as shown in FIG. 8, using the Basic Multi-gas Detector Model: FD4A Forensics Detectors, which had a detection range of methane (CH₄) of: 0-100% Lower Explosive Limit (LEL). The LEL of CH₄ is 5% of gas volume. The reading of HHH indicates that CH₄ has exceeded 100% LEL and is >5% of gas volume (>50,000 ppm).

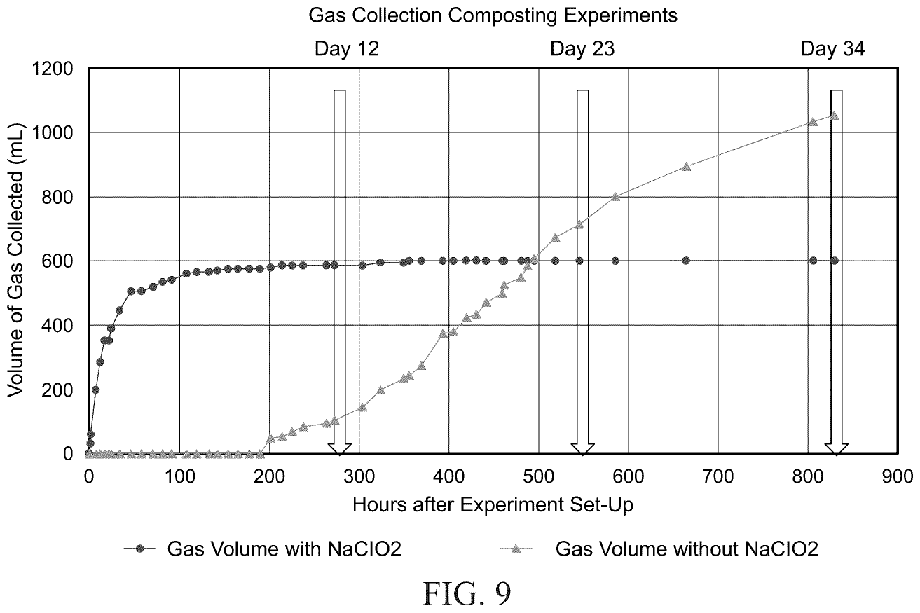

FIG. 9 and TABLE 1 show the gas composition produced by the anoxic composting systems shown in FIG. 6. As shown in FIG. 9, the gas composition was characterized at Day 12, Day 23, and Day 34 of the anoxic composting experiments with and without NaClO₂. As shown in TABLE 1, the gas composition of the gas produced from the from the anoxic composting model with wet creek bed soil with 16 g of NaClO₂ (9.6 g/kg soil concentration) had low levels of methane (0.75%) observed at Day 12 with no methane detected at Day 23 and Day 34. In contrast, as shown in TABLE 1, the gas composition of the gas produced by the anoxic composition model with wet creek bed soil with 0 g of NaClO₂ showed high levels of methane production including 4.75% methane at Day 12 and greater than 5% methane at Day 23, and Day 34.

TABLE 1
Methane Production (Volume %)

| | Methane % | Methane % | Methane % |
|---|---|---|---|
| | Day 12 | Day 23 | Day 34 |
| Anoxic Composting | 0.75% | 0% | 0% |
| Model with NaClO₂ | | | |
| Anoxic Composting | 4.75% | >5% | >5% |
| Model without NaClO₂ | | | |

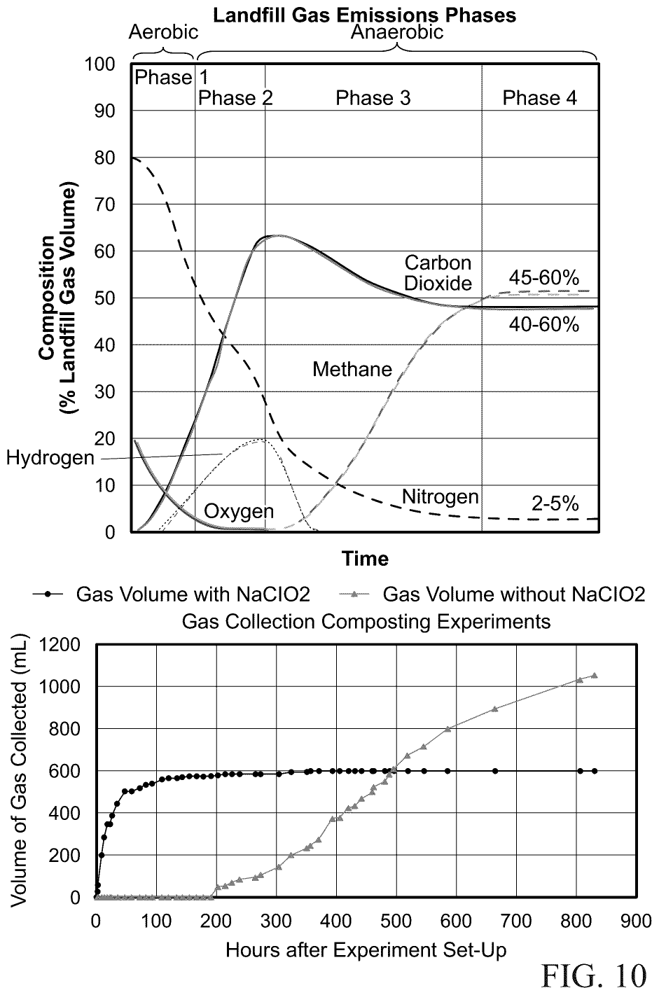

FIG. 10 shows a comparison between the gas emission phases in landfills and the gas production as observed in the anoxic composition models described above. Of note, the anoxic composting model without NaClO₂ produces a steady rate of methane production similar to Phase III and Phase IV of the gas emission phase in landfills. The use of NaClO₂ could prolong Phase I (aerobic decomposition) by the generation of oxygen and the reduction of methanogenesis.

### Conclusions

The chlorite dismutase (Cld) enzymes were shown to be present in creek bed soil samples from Denton Creek in Coppell, Texas. Using a combination of NaClO₂ and creek bed soil, about 14% of the expected volume of oxygen by the reduction of chlorite can be rapidly generated within a 65-hour period. The anoxic composting model system shows that sodium chlorite can significantly mitigate methanogenesis through the production of molecular oxygen and chloride (Cl⁻) by the reduction of chlorite by Cld enzymes. At the end of this study, no methane was detected in the composting model with NaClO₂ and methane gas volume exceeded the detection range of the gas meter in the composting model without NaClO₂. Thus, the molecular oxygen generated by the reduction of chlorite can promote aerobic respiration and prevent methanogenesis. The chloride (Cl⁻) generated by the reduction of chlorite can also inhibit the activity of fermentative/hydrolytoic bacteria, acetogens and methanogens responsible for the anaerobic decomposition and methane production. The results of this study demonstrate the use of chlorite and Cld enzymes can limit the production and emission of methane in waste management systems including municipal solid waste (MSW) landfills, vegetation waste disposal areas, and animal waste landfills.

### Example 2

Use of Chlorite Dismutase Enzymes to Reduce Methane Emissions from Landfills

Landfills in the United States account for 20% of its net methane emissions. This example describes experiments performed to test: 1) creek soil contains chlorite dismutase (Cld) enzymes capable of reducing sodium chlorite (NaClO₂) yielding oxygen gas and 2) use of Cld with NaClO₂ to promote aerobic decomposition and mitigate methanogenesis in an anoxic composting reactor modeling landfill biogases. It was hypothesized that alluvial creek bed soil is a rich microbial community containing chlorite dismutase (Cld), an enzyme capable of reducing sodium chlorite (NaClO₂) into oxygen. It was also hypothesized that the use of creek soil with NaClO₂ can promote aerobic decomposition of food waste and mitigate methanogenesis in an anoxic composting reactor mimicking a landfill.

With supplemental NaClO₂, biogas was rapidly detected in reactors with surface and deep creek soil suggesting Cld enzymatic activity in creek soil and its absence in landfill cover soil. 16S rRNA amplicon sequencing of surface and deep creek soil samples revealed similar proportions of microbial taxa at the phyla level with several shared phyla and genera containing a microorganism encoding Cld in its genome. Using an anoxic composting reactor, the impact of soil type (creek vs. landfill) and NaClO₂ on biogas volume and composition using gas-chromatography over 3 weeks was tested. Creek soil with NaClO₂ resulted in rapid onset of biogas production over initial around 60 hours with increasing CO₂ levels consistent with aerobic respiration. In reactors containing creek soil without NaClO₂, a delayed onset of biogas production at around Day 10 was observed and methane was detected with methane levels rising to about 32% by Day 21, consistent with anaerobic respiration and methanogenesis. Lower volumes of biogas production was observed in reactors with landfill soil that may be attributable to lower microbial content. Collectively, these results indicate that creek soil contain microorganisms with Cld and its use with NaClO₂ may promote aerobic respiration and inhibit methanogenesis under anoxic conditions.

### Methods

Creek bed soil was collected from the surface (12″) and deep creek bank soil (12″-18″) using a soil corer from a alluvial creek environment (Denton Creek in Coppell, Texas). Landfill soil cover was collected from City of Arlington landfill (Republic Services). The soil samples were characterized using Rapitest SoilTest Kit (Luster Leaf Products, Inc.).

A qualitative reactor for detection of gas production was designed and constructed using: 300 mL plastic water bottle, 7-inch balloon and 3×⅛ in rubber band. The surface creek soil, deep creek soil, and landfill soil cover samples were placed in qualitative reactor with 16 g NaClO₂ (30 g/kg soil concentration) and without any NaClO₂ to screen for the presence of Cld enzymes by observing the inflation of balloon indicating biogas production.

Extraction of genomic DNA from soil samples, PCR amplification of 16S rRNA genes of interest, generation of sequencing libraries was preformed using NEBNext Ultra DNA Library Pre Kit for Illumina, and sequencing of library on an Illumina platform generating 250 bp paired-end reads were performed by Novogene (Sacramento, CA). Data analysis by Novogene included paired-end reads assembly and quality control, operational taxonomic unit cluster and species annotation, and phylogenetic relationships were conducted using MUSCLE software.

An anoxic composting reactor was designed and constructed that comprised of a 2-liter plastic soda bottle attached to a 200 ml foil gas bag for quantitative gas analysis using gas chromatography. Composting experiments in anoxic composting reactor were conducted with 1 cup of organic food waste from kitchen waste with coffee grounds, 1 cup of leaves or grass clippings, 1 cup of shredded paper, and 4 cups of surface creek soil with 16 g of NaClO₂ (9.6 g/kg soil concentration) or 4 cups of surface creek soil without NaClO₂ or 4 cups of landfill cover soil with 16 g of NaClO₂, or 4 cups or landfill cover soil without NaClO₂.

Volumes of gas in the foil bags were estimated over a 3-week period. The gas samples were analyzed for fixed gases (hydrogen, oxygen, nitrogen, carbon monoxide, methane, and carbon dioxide) according to modified EPA Method 3C (single injection) using a gas chromatograph equipped with a thermal conductivity detector by ALS Environmental (Simi Valley, CA).

### Results

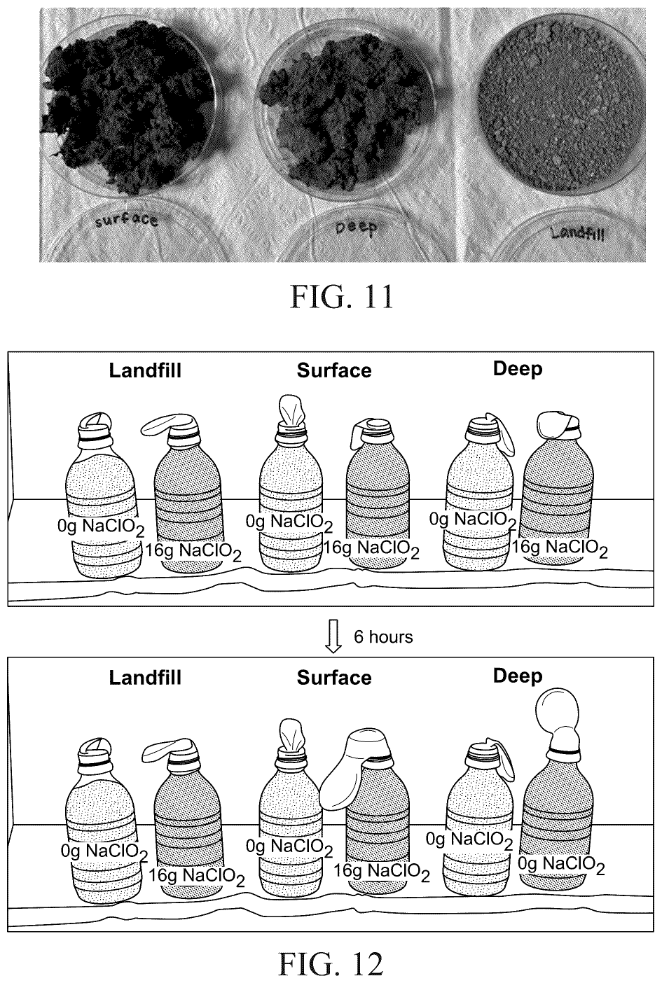

FIG. 11 shows the soil samples collected from the surface (12″), deep creek bank soil (12″-18″), and landfill soil cover. TABLE 2 below provides measured characteristics of each of the soil samples collected.

TABLE 2
Characteristics of Soil Samples Collected

| | Soil Type | | |
|---|---|---|---|
| | Surface Creek | Deep Creek | Landfill |
| | Soil | Soil | Cover Soil |
| Components | Clay, silt, | Clay, silt, | Sand |
| | organic material | organic material | |
| DNA Concentration | 16.5-25.8 | 11.8-14.3 | <min |
| (ng/μl) | | | |
| Water Holding | GOOD | GOOD | POOR |
| Capacity | | | |
| Nutrient Holding | GOOD | GOOD | POOR |
| Capacity | | | |
| pH | 7.5 | 7.5 | 7.0 |
| Nitrogen | Deficient | Deficient | Adequate |
| Phosphorous | Adequate | Adequate | Adequate |
| Potassium (Potash) | Deficient | Deficient | Deficient |

The soil samples collected were then used for the detection of Cld enzymes using a qualitative reactor for observation of gas production, as shown in FIG. 12. As shown in FIG. 12, the surface creek soil and deep creek soil samples with 16 g NaClO₂ (30 g/kg soil concentration) showed rapid balloon inflation within 6 hours suggesting Cld enzymatic activity. Also shown in FIG. 12, the surface creek soil, deep creek soil, and landfill cover soil samples without NaClO₂ and the landfill cover soil with 16 g NaClO₂ (30 g/kg soil concentration) did not show any balloon inflation.

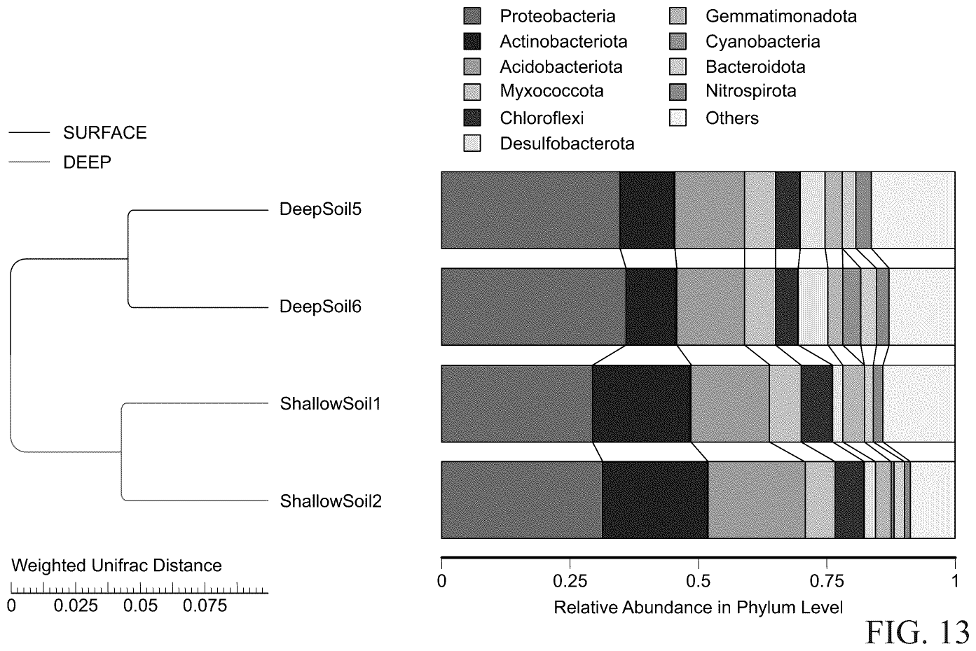

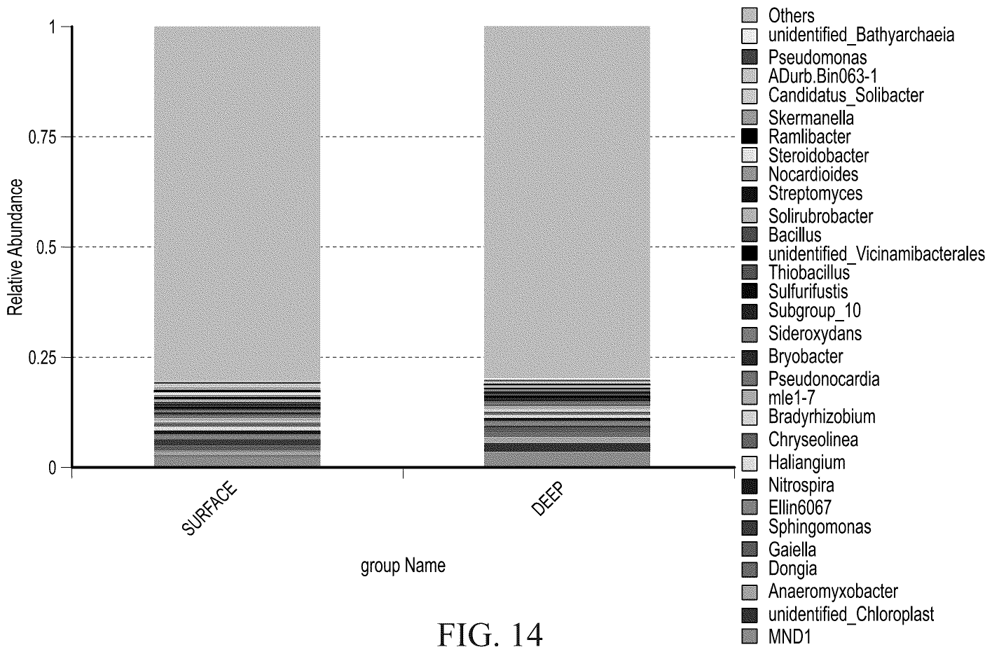

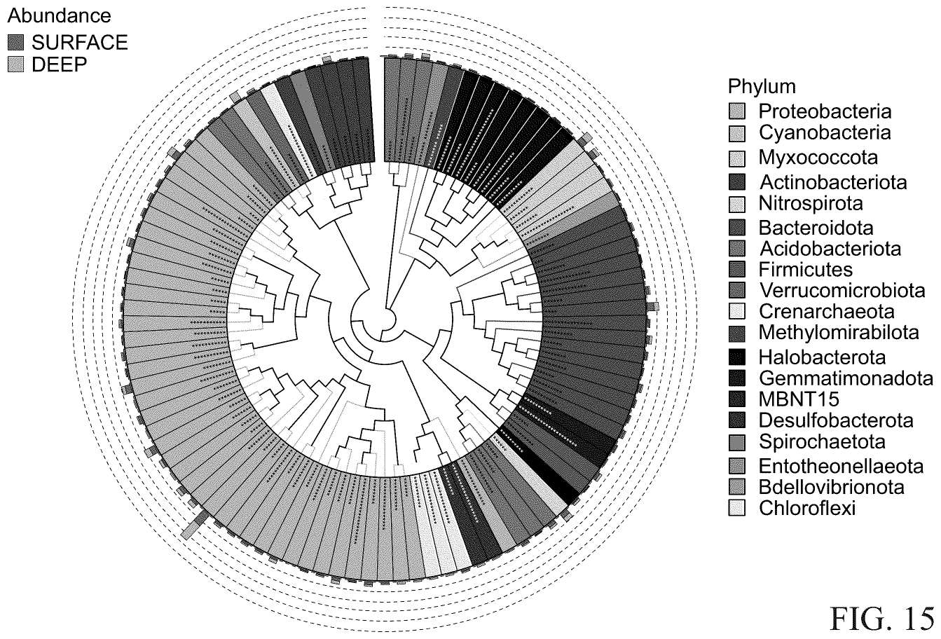

The metagenomics of the Alluvial creek soil environment was then evaluated. FIG. 13 shows the relative proportion of top phyla in the soil samples and shows that the relative proportions are comparable between the deep and surface soil samples. Of the 10 phyla observed in both the deep and surface soil samples, four are known to contain the Cld enzymes based on published genome sequencing studies including: Proteobacteria (2%), Chloroflexi (1%), Actinobacteria (<1%), and Firmicutes (<1%). Further shown in FIG. 14, amongst the top 30 genera in the surface and deep soil were the following genera known to harbor Cld enzymes: Bradyrhizobium (75%), Nitrospira (40%), Sphingomonas (5%), and Pseudomonas (1%). To further study the phylogenic relationship of the microbial communities in the soil samples, the top 100 genera were selected for an evolutionary tree, as provided in FIG. 15. As shown in FIG. 15, of the top 100 genera, 9 are known to harbor Cld enzymes. Of note, Nitrospira (40% with Cld) and Sphingomonas (5% with Cld) were relatively abundant in both the surface and deep soil samples collected. Additionally, at least two genera were detected that were well characterized to produce methane including Methanosaeta and Candidatus methanoperedens.

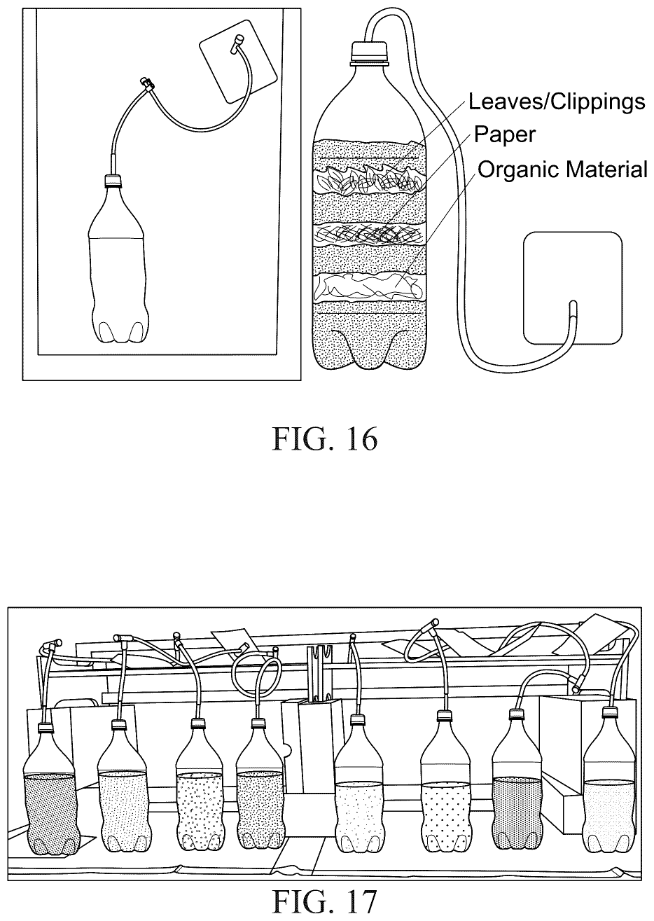

The biogas produced from the anoxic composting reactors comprising creek soil or landfill cover soil augmented with NaClO₂ was then quantified. The anoxic composting reactor design and system for collecting biogas and to model landfill biogas emissions is provided in FIG. 16. As shown in FIG. 16, the anoxic composting reactors contain soil samples layered with food waste and other organic materials found in landfills (e.g., leaves/clippings, paper, and organic material).

FIG. 17 provides the set-up of the anoxic composting reactors following four experimental conditions including a technical replicate for each: (a) 4 cups of surface creek soil with 16 g of NaClO₂ (9.6 g/kg soil concentration); (b) 4 cups of surface creek soil without NaClO₂; (c) 4 cups of landfill cover soil with 16 g of NaClO₂ (9.6 g/kg soil concentration); and (d) 4 cups of landfill cover soil without NaClO₂.

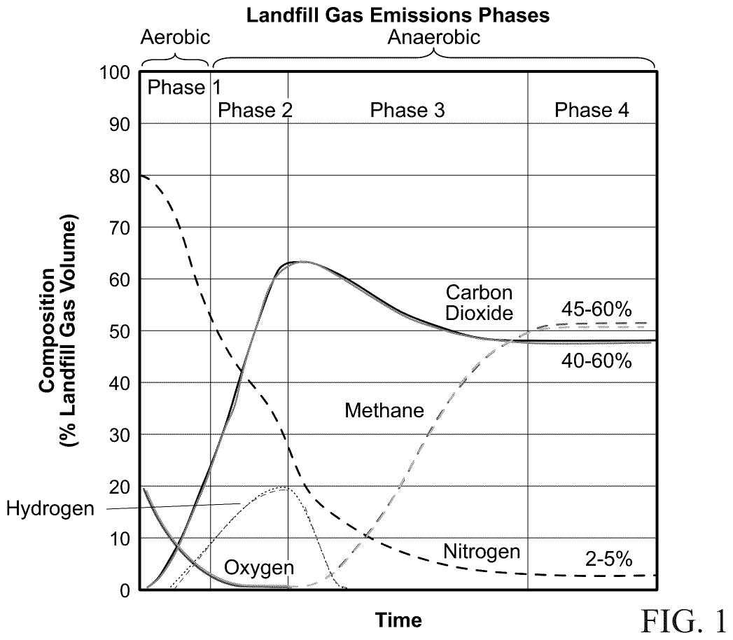

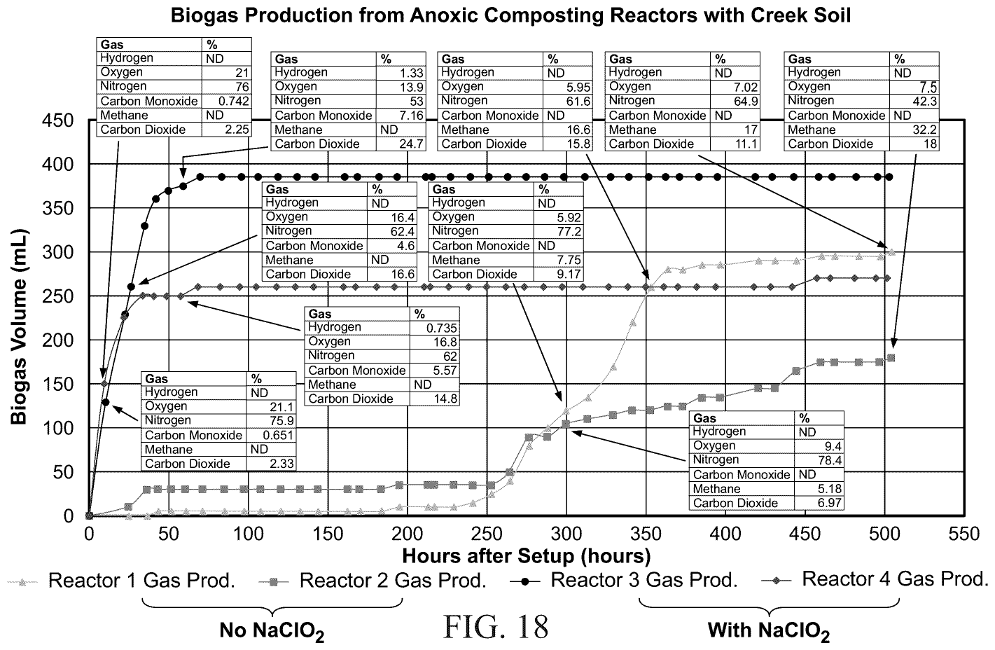

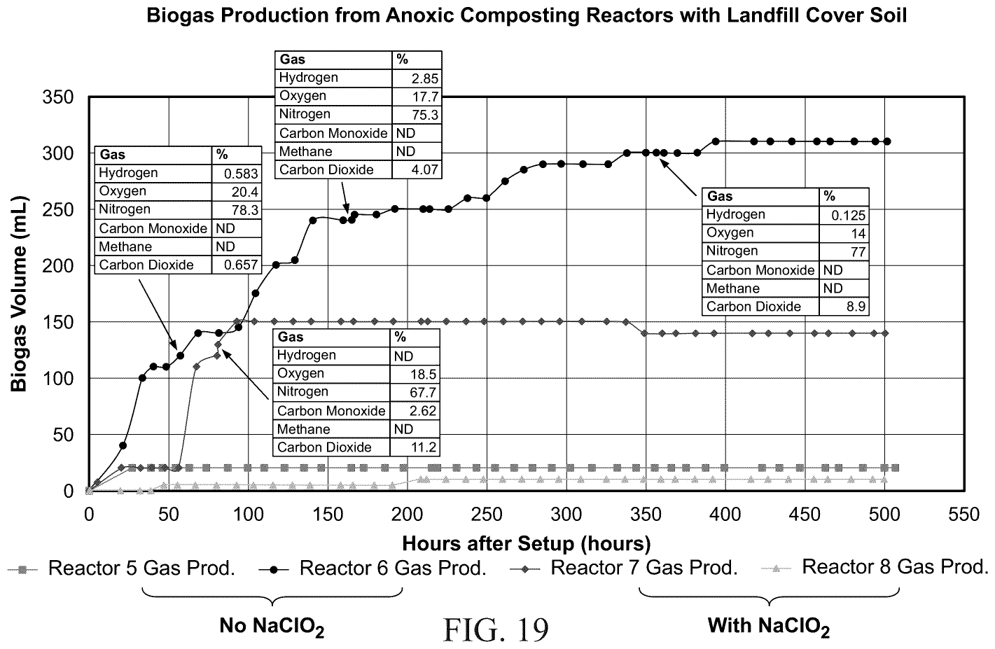

FIG. 17, provides the quantification and characterization of the biogas produced from the anoxic composting reactors comprising creek soil. As shown in FIG. 18, the anoxic composting reactors with surface creek soil samples mimic the 4 phases of bacterial decomposition in landfills (e.g., the phases provided in the schematic of FIG. 1). Further shown in FIG. 18, the anoxic composting reactors with surface creek soil and 16 g of NaClO₂ (9.6 g/kg soil concentration) resulted in immediate gas production over a 60-hour period with increasing levels of CO₂, consistent with aerobic respiration. Also shown in FIG. 18, the anoxic composting reactors with surface creek soil without NaClO₂ resulted in a delayed onset of gas production around Day 10 when methane was detected and the methane levels rise to around 32% at Day 21, consistent with anaerobic respiration and high levels of methanogenesis. A larger volume of biogas was produced in creek soil reactors with NaClO₂ (328 ml+/−81) compared to creek reactors without NaClO₂ (240 ml+/−85 ml) (P-value=0.009, one-tailed paired t test). The millimoles of methane generated in creek soil reactors without NaClO₂ (mean=1.6+/−0.3) was significantly higher than in creek reactors with NaClO₂ (P-value=0.037, one-tailed paired t test). FIG. 18, provides the quantification and characterization of the biogas produced from the anoxic composting reactors comprising landfill cover soil. As shown in FIG. 19, the anoxic composting reactors with landfill soil cover samples with or without NaClO₂ generated gas with lower levels of CO₂ consistent with lower levels of aerobic respiration. Biogas volumes were lower in landfill reactors (mean=120 ml+/−139) compared to that observed in creek reactors (mean=284 ml+/−85) likely due to lower microbial content.

### Conclusions

Alluvial creek bed soil samples from Denton Creek in the presence of NaClO₂ resulted in rapid gas formation suggesting the presence of Cld enzymatic activity. Metagenomics studies of creek soil revealed that this environment harbors a rich microbial community including several phyla and genera containing a microorganism encoding Cld in its genome. Quantitative biogas studies using an anoxic composting reactor suggests creek soil with NaClO₂ results in early onset of biogas production which appears to promote robust aerobic respiration. In the anoxic composting reactors with creek soil and no NaClO₂, it was observed a delayed onset of biogas production with high composition of methane consistent with high levels of anaerobic respiration and methanogenesis. Interestingly, the combination of Cld containing creek soil with NaClO₂ in the reactor appears to prevent methanogenesis. Biogas production from the anoxic composting reactors with landfill soil cover was lower than that observed in the reactors with creek soil likely due to lower microbial content in landfill soil. Collectively, the results of this study indicate that the use of soil rich in Cld enzymes and its substrate NaClO₂ may represent a promising bio-inspired environmental engineering approach to mitigate methane emissions from landfills.

The results of this study suggest that the use of Cld enzymes and NaClO₂ have the potential to limit the emissions of methane in landfills including municipal waste landfills, vegetation waste disposal areas, and animal waste landfills when it is technically or economically not feasible to recover the methane gas for energy production. Use of Cld enzymes and NaClO₂ represents a promising bio-inspired environmental engineering solution to mitigate methane emissions from landfills.

Although the invention has been described with reference to the above examples, it will be understood that modifications and variations are encompassed within the spirit and scope of the invention. Accordingly, the invention is limited only by the following claims.

What is claimed is:

1. A method of reducing of reducing biogas levels or anerobic activity of a microorganism in a waste management system comprising contacting the waste management system with a chlorite (ClO₂⁻) containing compound, a chlorate (ClO₃⁻) containing compound, a perchlorate (ClO₄⁻) containing compound, or a combination thereof.

2. A method of increasing oxygen levels in a waste management system comprising contacting the waste management system with a chlorite (ClO₂⁻) containing compound, a chlorate (ClO₃⁻) containing compound, a perchlorate (ClO₄⁻) containing compound, or a combination thereof.

3. A method of promoting aerobic respiration of a microorganism in a waste management system comprising contacting the waste management system with a chlorite (ClO₂⁻) containing compound, a chlorate (ClO₃⁻) containing compound, a perchlorate (ClO₄⁻) containing compound, or a combination thereof.

4. (canceled)

5. The method of claim 1, further comprising contact the waste management system with a chlorite dismutase (Cld) enzyme, a chlorate reductase (Clr) enzyme, a perchlorate reductase (Pcr) enzyme, or a combination thereof.

6. The method of claim 1, further comprising contacting the waste management system with a population of microorganisms expressing one or more of a chlorite dismutase (Cld) enzyme, a chlorate reductase (Clr) enzyme, and a perchlorate reductase (Pcr) enzyme.

7. The method of claim 6, wherein the population of microorganisms are engineered to express one or more of the chlorite dismutase (Cld) enzyme, the chlorate reductase (Clr) enzyme, and the perchlorate reductase (Pcr) enzyme.

8. The method of claim 7, wherein the population of microorganisms comprises bacteria, archaea, or a combination thereof.

9. The method of claim 1, wherein the chlorite (ClO₂⁻) containing compound is sodium chlorite (NaClO₂).

10. The method of claim 1, wherein chlorate (ClO₃⁻) containing compound is sodium chlorate (NaClO₃), potassium chlorate (KClO₃), or magnesium chlorate Mg(ClO₃)₂.

11. The method of claim 1, wherein perchlorate (ClO₄⁻) containing compound is sodium perchlorate (NaClO₄), ammonium perchlorate ([NH₄]ClO₄), perchloric acid (HClO₄), or potassium perchlorate (KClO₄).

12. The method of claim 1, wherein the biogas is methane, carbon dioxide, or a combination thereof.

13. The method of claim 3, wherein the microorganism is a bacteria or an archaea.

14. The method of claim 1, wherein the microorganism is a bacteria or an archaea.
